(19) United States
(12) Patent Application Publication
(10) Pub. No.: US 2020/0214197 A1
(43) Pub. Date: Jul. 9, 2020

(54) SICKLE SECTION AND KNIFEBACK AND SECTION JOINT

(71) Applicants: Joseph W. Schaffer, Colgate, WI (US); Neal J. Stoffel, Campbellsport, WI (US)

(72) Inventors: Joseph W. Schaffer, Colgate, WI (US); Neal J. Stoffel, Campbellsport, WI (US)

(73) Assignee: Kondex Corporation, Lomira, WI (US)

(21) Appl. No.: 16/724,668

(22) Filed: Dec. 23, 2019

Related U.S. Application Data
(60) Provisional application No. 62/788,029, filed on Jan. 3, 2019.

(51) Int. Cl. A01D 34/14

(52) U.S. Cl. CPC A01D 34/14

(57) ABSTRACT

A sickle bar assembly is provided including a sickle bar for mounting a plurality of sickle cutting sections along a length of the sickle bar. The sickle bar has a first bar surface and a second bar surface. A bar thickness is defined between the first bar surface and the second bar surface. A plurality of bar apertures extend through the first and second bar surfaces and are arranged to facilitate mounting of the sickle cutting sections. The first bar surface includes a non-flat surface region comprising a plurality of indentations formed therein.

### CROSS-REFERENCE TO RELATED PATENT APPLICATIONS

This patent application claims the benefit of U.S. Provisional Patent Application No. 62/788,029, filed Jan. 3, 2019, the entire teachings and disclosure of which are incorporated herein by reference thereto.

This invention generally relates to agricultural parts, and more specifically to sickle bar assemblies including knifebacks, knife heads, and knife sections.

### BACKGROUND OF THE INVENTION

Typical sickle bar assemblies include a knife back, also referred to as a sickle bar, and knife sections, also referred to as sickle cutting sections, that are attached to the sickle bar. A knife head can be mounted onto the sickle bar to drive the sickle bar back and forth. As the sickle bar is driven in a reciprocating fashion its sickle cutting sections move over knife guards to cut a crop or other organic growth. Typically, sickle bar assemblies are used in harvesters, mowers or other commercial or even residential machines. Various examples of the sickle bar assemblies and their components are disclosed, for example, in U.S. Pat. Nos. 4,854,114; 8,371,096 and 6,467,246, the entire teachings of which are incorporated herein by reference.

### BRIEF SUMMARY OF THE INVENTION

Embodiments of the invention may improve the useful life of a sickle bar arrangement by improving the useful life of any one of or combinations of parts that make up the sickle bar assembly, namely, the sickle bar, the sickle cutting sections; and/or the knife head.

Some embodiments create residual compressive stress by using cold roll forming or coining or shot peening to create a non-flat surface region. The non-flat surface region comprises a plurality of indentations formed in at least a first surface of any one of or combinations of the sickle bar or the sickle cutting section or the knife head. In embodiments of the sickle bar, the at least one non-flat region may be formed in one or more surfaces of the sickle bar. For example, compressive stress formed regions (which may be referred to as a non-flat region) can be applied to the top or bottom surface of the sickle bar or both top and bottom surfaces. Further, the entire top and/or bottom surface may be compress stress formed or select areas subject to greater loading during use.

The non-flat surface region may resemble a pattern. The pattern may be any designed coining pattern including circle patterns or may resemble knurling patterns such as male and female diamond patterns, straight pattern spline, left or right hand diagonal pattern, or a combination thereof. Further, the pattern may be a regular pattern.

In an embodiment of the sickle bar, the non-flat surface region is formed in spaced apart locations proximate opposed ends of the sickle bar with a flat surface region along the first bar surface between the spaced apart locations. The flat surface regions may not be compress stress formed.

In an embodiment of the sickle bar, the non-flat surface regions extends over the entire length along the first bar surface.

In an embodiment of the sickle cutting section, the first surface includes a mounting portion and the at least one non-flat surface region is formed in the mounting portion.

In an embodiment of the knife head, the first surface is a mating surface and the at least one non-flat surface region is formed in the mating surface.

Not only is fatigue strength improved in the sickle bar assembly through the process and result of creating residual compressive stress in any one of or any combination of the sickle bar, the sickle cutting section and the knife head, but in embodiments the at least one non-flat region may form a pattern. Accordingly, the pattern formed in the at least one non-flat surface region on at least the first surface can be matched with an inverse pattern formed in a mating part such that when the parts are mated they create an interlock between them. In this arrangement, it is preferred to be compressive stress formed; but also may be machined or otherwise formed in other embodiments.

Thus, part mating robustness and/or improved useful life of each part and thus the sickle bar assembly may be achieved through the mechanical interlocking of the mating parts. By mating parts it is meant the sickle cutting section that mates with the sickle bar; and the knife head that mates directly with the sickle bar; or the knife head that mates with a top surface of the sickle cutting section which in turn mates with the sickle bar to drive the sickle bar assembly.

The part mating robustness may improve fatigue strength in the sickle bar, the sickle cutting section, and the knife head and in fasteners that may be used to connect them and thereby the useful life of each part and thus the sickle bar assembly may be improved.

Locating and joining mating parts using the interlock pattern may combine added fatigue strength with greater surface contact area and load carrying of mating parts. This may enhance the sickle assembly's ability to support transverse, longitudinal, diagonal, and bending loads.

Part-to-part mating via the mechanical interlocking may reduce fretting and joint clamp load vulnerability through the joint's increased friction and load handling capability. Bearing surface area and characteristics may spread the sickle assembly's loads evenly reducing reliance on fastener clamp load alone. Less reliance on clamp load and more friction means the fastener or fasteners joining the mating parts no longer carries system working loads that may ultimately result in fracture origins in the sickle bar, sickle cutting section, knife head or fasteners.

Because the mechanical interlocking feature between mating parts may improve the fatigue strength and may increase the useful life of the parts and assembly, apart from, that is, independent of the process and result of creating residual compressive stress, then the at least one non-flat surface region of the sickle bar, the sickle cutting section, or the knife head may be formed from machining or other material removal processes.

Mechanically interlocking the sickle bar to the sickle cutting sections allows for an embodiment wherein the fastening system of the sickle cutting section to the sickle bar is reduced from two fasteners to a single fastener combined or not with any shape washer or clamp load spreading and retention mechanism. The fastener system which utilizes only a single fastener to secure each sickle cutting section to the sickle bar reduces the sickle assembly mass, cost, and failure origin possibilities by reducing fastener count by 50%. This fastening scheme may facilitate quick change of sections in the field. Fast field service is further simplified by enabling section removal without removal of the fastener. This is achieved by using a slot mounting arrangement in the sickle cutting section. Use of a slot is effective because the engineered mating pattern of the joined parts reduces the reliance of locating and load carrying from the fasteners. Further, with use of the slot, the shaft size of the bolt may be greater than the shaft size of the two bolts used to secure the sickle section having a mounting portion with two apertures and may withstand forces that had been directed to the two bolts.

Another feature created by the formed pattern on at least a first mating surface of the sickle bar may be that the at least one non-flat surface region creates a pattern that provides a self-cleaning for the sickle bar. For example, the self-cleaning effect is similar to that produced via tire treads which extract, for example mud, moisture and snow.

As has been discussed, by mating parts it is meant that the sickle bar that mates with the one or more sickle cutting sections and or the sickle bar that may mate with the knifeback header. Some embodiments of the invention contemplate that only one surface of the mating parts has the at least one non-flat surface region. Thus, the second part's mating surface may be entirely flat without a non-flat region. This is so because the at least one non-flat surface region when mated with a flat surface on the mating part produces joint robustness. Fatigue strength may be improved because the formed part may impress its pattern on the mating part surface and thereby increases friction and load bearing area. Thus, it may improves retention through a “grip effect.” Accordingly, in embodiments one surface of the mating parts has the non-flat region because it may be enough to improve the joint robustness between the parts.

By “flat” it is meant in the sense of the ordinary meaning of the word and/or as applied to steel bar stock. Generally, flat regions are without formed lumps or indentations from cold forming or machining operations to the bar stock. Further, a surface having apertures, for example, according to the teachings herein, are considered “flat” but a surface with formed or machined indentations that do not extend completely through a top and bottom surface are not to be considered flat. Further, surface imperfections of the bar stock or sheets from which the sickle bars, sickle cutting section or knife head are to be understood as flat surfaces.

In embodiments where the mating surfaces of the mating parts each include at least one non-flat surface region, for example, the sickle bar mating with the sickle cutting section, then the non-flat surfaces may also define a registry with spacing such that the sickle cutting sections are moveable along the registry at intervals corresponding to the spacing. Further, a shaft of a fastener may also extend through apertures of the sickle bar and the sickle cutting sections such that the shaft is sized smaller that the apertures to define a clearance gap sufficiently large enough to permit relative movement between the sickle bar and the sickle cutting section of at least the clearance gap.

In embodiments where mechanical interlock is not desired, the non-flat surface regions can be formed on the first surface and/or the second surface in a pattern that is irregular such as that provided by shot peening. However, shot peening as a cold forming process creates the residual compressive stress that may improve the fatigue strength of the part and in addition where such an irregular pattern is formed, the friction fit with a flat surface of a mating part may be provided and further, the self-cleaning benefit may be achieved.

The sickle cutting sections or sickle bars or knife heads that heretofore have been described and will be described hereafter, may be used in a method that provides for them to be used individually or in combination as replacement parts in the field to improve the useful life of the parts and in turn the sickle bar assemblies that they form.

Where the cold forming process is used to form the non-flat regions in any of the sickle bar, sickle cutting section or knife head, the sharpness of the surface at the opening of the apertures may be reduced because the cold forming process rounds the edge. Rounding the edge may reduce the stress riser of the previously sharp edge and thus may improve the fasteners and apertures useful lives by improving their fatigue life.

In one aspect, an embodiment the invention provides a sickle bar for mounting a plurality of sickle cutting sections along a length of the sickle bar. The sickle bar includes a first bar surface and a second bar surface (for example, top and bottom surfaces). A bar thickness is defined between the first bar surface and the second bar surface. A plurality of bar apertures extend through the first and second bar surfaces arranged to facilitate mounting of the sickle cutting sections. The first bar surface includes a non-flat surface region comprising a plurality of indentations formed therein.

In another aspect, an embodiment of the invention provides a sickle cutting section. The sickle cutting section includes a plate. The plate has a first surface and a second surface. The first and second surfaces extend between an end of the plate to a tip of the plate. The plate has a plate thickness defined between the first surface and the second surface. The plate includes a mounting portion that extends a partial distance from the end to the tip. The mounting portion defining a mounting aperture and a wedge portion that extends from the mounting portion to the tip of the plate. The wedge portion defines a cutting edge. The first surface of the plate along the mounting portion defines a first non-flat surface.

In yet another aspect, an embodiment of the invention provides a sickle bar assembly. The sickle bar assembly includes a first sickle bar and a plurality of sickle cutting sections. Each one of the plurality of sickle cutting sections includes a plate comprising a first surface and a second surface. The first and second surfaces extend between an end of the plate to a tip of the plate. A plate thickness is defined between the first surface and the second surface. A mounting portion extends a partial distance from the end to the tip. The mounting portion defines at least a first mounting aperture. A wedge portion extends from the mounting portion to the tip of the plate. The first surface of the mounting portion defines a first non-flat sickle cutting section surface. At least two of the plurality of sickle cutting sections are secured to the first sickle bar in side by side relation along a length of the first sickle bar.

In still another aspect, an embodiment of the invention provides for a method for forming the non-flat surface region in a first surface of the sickle bar or the sickle cutting section or the knife head or along mating surfaces of the sickle bar and sickle cutting sections or along mating surfaces of the sickle cutting section of the knife head.

In an embodiment the forming is by a pressing that imparts a residual compressive stress in the part. Examples may include knurling, shot peening, or other pressing.

In an embodiment the forming is by machining or other material removal processes.

In still another aspect, an embodiment of the invention provides for a knife head, the knife head having a first surface, a second surface and a thickness defined between the first surface and the second surface. A plurality of apertures for mounting the knife head to a sickle bar extend evenly spaced from a proximal end to a distal end of the knife back. A non-flat surface region is formed in the second surface and extends along the entire length of the second surface from the proximal end to the distal end.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top side isometric view of a sickle bar assembly and knife head (the non-flat regions being shown schematically) according to the teachings of the instant application;

FIG. 2 is an isometric assembly view of the sickle bar assembly of FIG. 1;

FIG. 3 is an isometric top view of the sickle bar of FIG. 1;

FIG. 4 is a isometric bottom view of the sickle bar of FIG. 1;

FIG. 5 is an enlarged top view of a pressed or knurled pattern formed in the top surface (optionally the bottom surface) of the sickle bar of FIG. 1;

FIGS. 6 and 7 are respective top and bottom schematic views of an embodiment of a sickle bar;

FIGS. 8 and 9 are respective top and bottom schematic views of another embodiment of a sickle bar;

FIGS. 10 and 11 are respective top and bottom schematic views of yet another embodiment of a sickle bar;

FIGS. 12 and 13 are respective top and bottom schematic views of yet another embodiment of a sickle bar;

FIGS. 14 and 15 are respective top and bottom schematic views of still another embodiment of a sickle bar;

FIG. 16-19 are schematic illustrations of alternative patterns that may be formed along the top and/or bottom surfaces of the sickle bars;

FIG. 20 is an isometric bottom view of the sickle cutting section of FIG. 1;

FIG. 21 is an enlarged plan view of an inverse pattern formed in the sickle cutting section of FIG. 1;

FIG. 22 is another enlarged but isometric view of the inverse pattern formed in the sickle cutting section of FIG. 1;

FIG. 23 is an isometric top view of the sickle cutting section of FIG. 1;

FIG. 24 is a schematic bottom view of an embodiment of the sickle cutting section;

FIGS. 25-28 are schematic illustrations of alternative patterns that may be formed in the sickle cutting section;

FIG. 29 is an enlarged vertical cross section of a portion of a sickle bar assembly to show patterns that interlock between the sickle cutting section and sickle bar;

FIG. 30 is an isometric top view of another embodiment of a sickle assembly according to the teachings of the instant invention;

FIG. 31 is a schematic bottom view of the knife head of FIG. 1;

FIG. 32 is a schematic view of an alternative bottom surface of the knife head of FIG. 1;

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

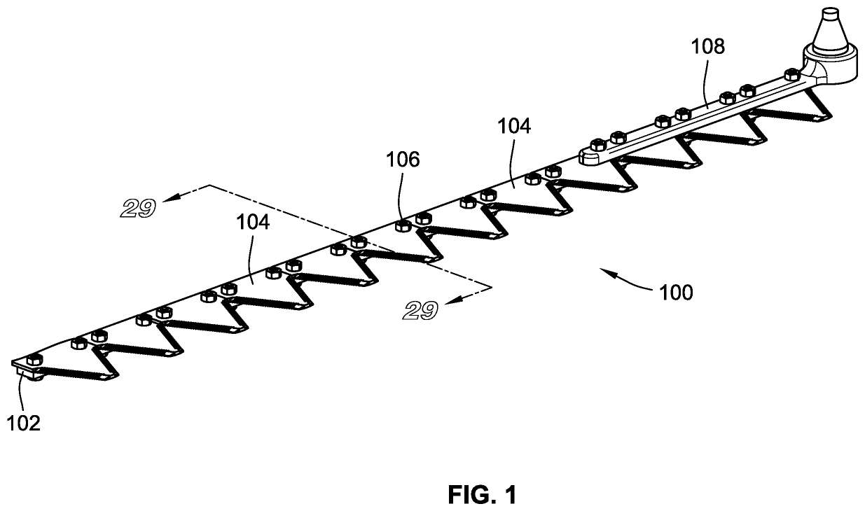

FIG. 1 is a top view of a sickle bar assembly 100 and knife head 108 according to an embodiment of the present invention. The sickle bar assembly 100 includes a sickle bar 102 and a plurality of sickle cutting sections 104 mounted to the sickle bar 102 along its length with fasteners 106. A knife head 108 joins to the sickle bar assembly 100 to drive the sickle bar 102. Typically, the sickle bar 102, the sickle cutting sections 104 and the knife head 108 are made from steel or alloy steel.

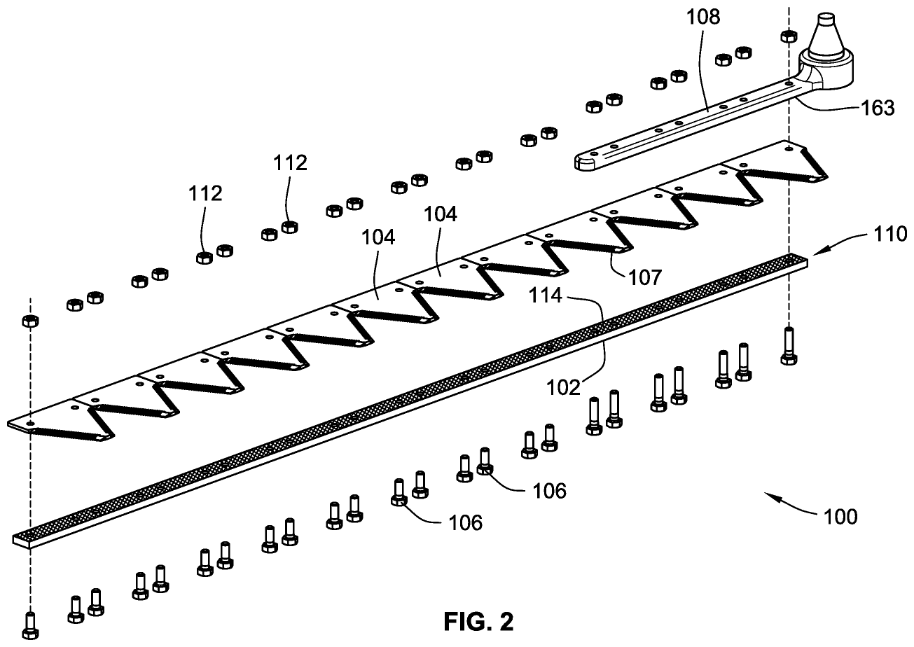

FIG. 2 is an assembly view of the sickle bar assembly 100 and knife head 108. The knife head 108 mounts over several of the sickle cutting sections 104 at a first bar end 110 of the sickle bar 102 so as to connect to the sickle bar 102 to the knife head 108. Alternatively, the knife head 108 could mount directly to the sickle bar 102. In either case the fasteners 106, which may be bolts with nuts 112 and preferably washers connect the knife head to the sickle bar 102 so that the knife head 108 can drive the sickle bar 102 and its sickle cutting sections 104 in reciprocating motion.

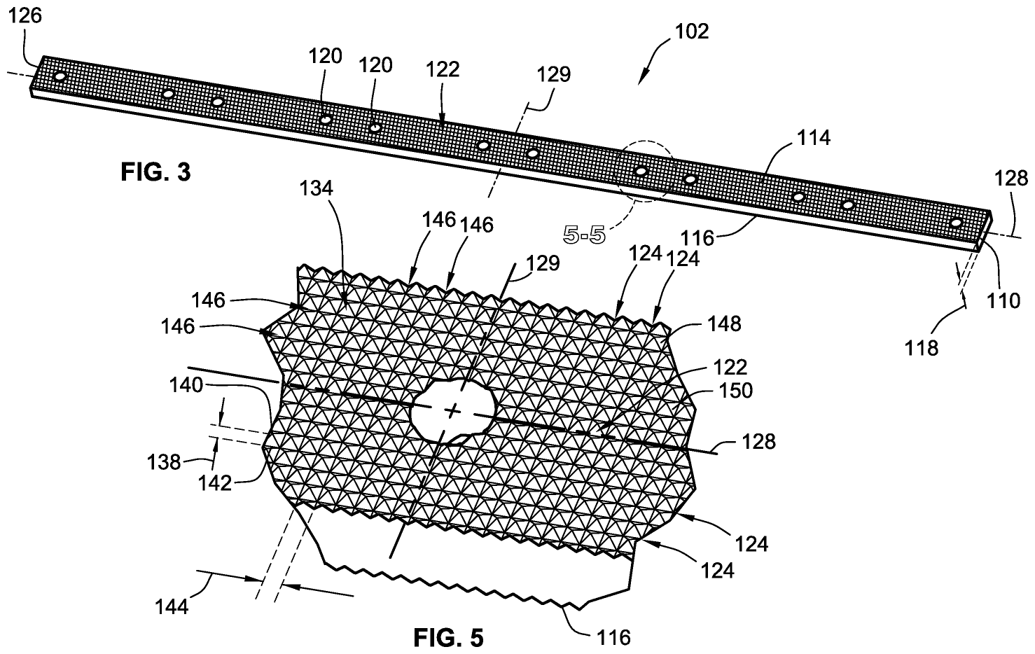

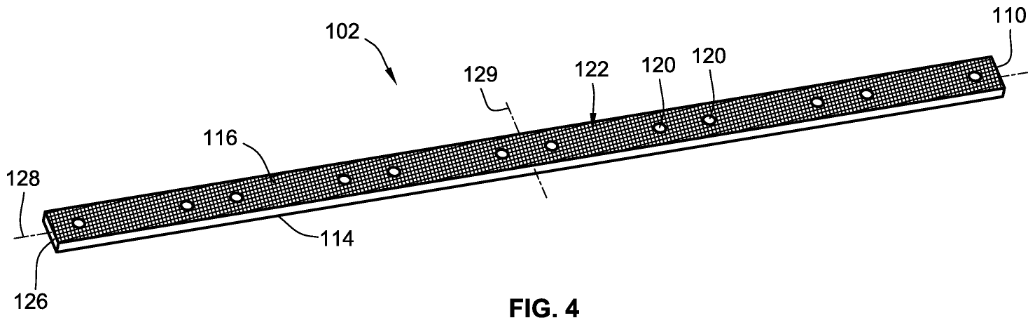

FIGS. 3 and 4 illustrate a top view and bottom view, respectfully, of the sickle bar 102 of FIG. 1. The sickle bar 102 has a first bar surface 114 and a second bar surface 116 (e.g. top and bottom surfaces) with a bar thickness 118 defined between the first bar surface 114 and the second bar surface 116. A plurality of bar apertures 120 extend through the first bar surface 114 and the second bar surface 116 and are arranged, that is located, to facilitate mounting of the sickle cutting sections 104 (FIG. 1).

The sickle bar 102 is typically of a length extending between a first end 110 and a second end 126 of between 0.3 and 15.3 meters, a width of between 1.3 and 10.6 cm and the bar thickness 118 of between 4.7 and 20 mm. More typically, the sickle bar 102 length will be at least 4 meters, a width of at least 5 cm and a thickness of at least 10 mm.

The top first bar surface 114, as better seen in FIG. 5, includes a non-flat surface region 122 comprising a plurality of indentations 124 formed therein. The same non-flat surface region is formed in the bottom second bar surface 116. The plurality of formed indentations 124 are meant to include preferably knurled or coined features, but may also include indentation features formed from machining or other material removal. A non-removal pressing process such as coining, stamping, knurling, other press deformation or the like is more preferred due to strength enhancements by metal material stress adjustment due to compressive forces created during pressing and preventing micro fractures at the first bar surface 114 and/or the second bar surface 116, to provide potential strength enhancements, and may also be used for mechanical interlock with sickle cutting sections 104 (FIG. 1). Alternatively, removal techniques such as machining or other material removal or cutting may be used to form the plurality of indentations 124 for mechanical interlock with the sickle cutting sections 104 (FIG. 1) or for friction fit with embodiments of sickle cutting sections having flat mounting surfaces.

Also, the sickle bar 102 may be hardened by any known techniques such as, by way on a non-limiting example, heat treating, prior to after the forming of the non-flat surface regions 122. However, in other embodiments the sickle bar 102 is not hardened prior to or after the forming processes.

In the embodiment of the sickle bar 102 illustrated in FIG. 2, the non-flat surface region 122 is cold formed and plastically deformed with the plurality of indentations 124 press formed into the first bar surface 114 and the second bar surface 116 in a pattern 134 that is a regular pattern. However, a cold formed irregular pattern could be formed by a process such as shot peening, although a mechanical interlock with another mating part surface would not be available with such a formation process.

The non-flat surface region 122 extends completely over the entire length of the sickle bar 102 from the first bar end 110 to the second bar end 126 along the first bar surface 114 and second bar surface 116. The sickle bar 102 defines a longitudinal axis 128 along its length and a horizontal axis 129 perpendicular to the longitudinal axis 128. It should be noted that herein, indentations 124 are not to be understood as apertures, as apertures define a through hole while indentations 124 do not form a through hole and instead press the surfaces 114, 116 they are formed in, or in the case of material removal, remove material, but not to the extent that a through hole is created.

FIG. 5 is an enlarged view of a portion of the non-flat surface region 122 that may be on the top first bar surface 114 or the bottom second bar surface 116 or both. The non-flat surface region 122 may be formed in a pattern 134. It may be a pattern 134 that is regular or may, where mechanical interlock is not desired, be irregular such as for example in shot peening. The pattern 134 may be any designed coining pattern including circle patterns or may resemble knurling patterns such as male and female diamond patterns, straight pattern spline, left or right hand diagonal pattern, or a combination thereof.

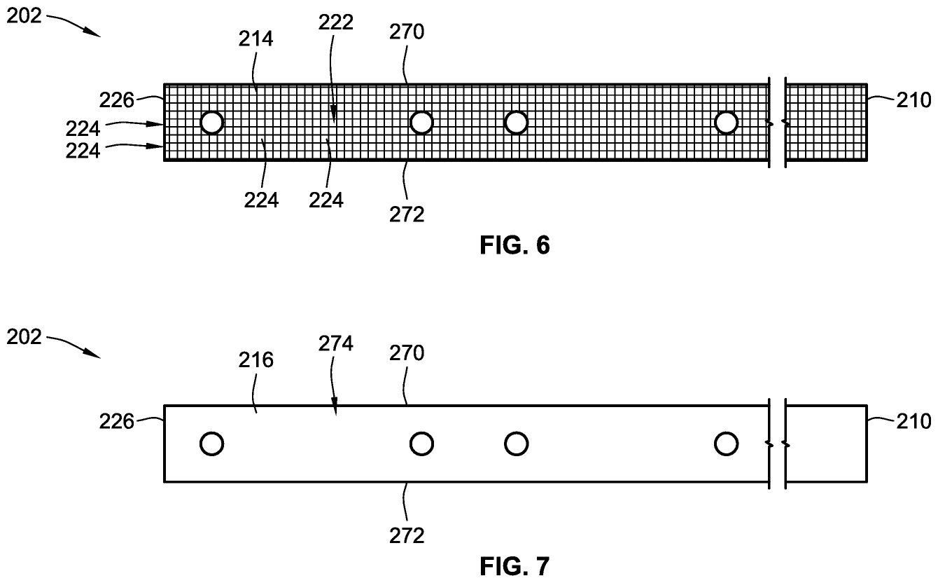

Further, the pattern 134 may be an interlocking pattern in the sense that by interlock it is meant the pattern 134 is able to cooperate with an inverse pattern 136 (FIG. 6) on a mating part, either the sickle cutting section 104 (FIG. 2) or knife head 108 (FIG. 2) to establish a mechanical interlock. Typically, the pattern 134 is on the top first bar surface 114 of the sickle bar 102.

Still with respect to FIG. 5, the plurality of indentations 124 define an indentation depth 138. The indentation depth 138 is measured from an exterior 140 that may be (e.g. defined by projections or tips) of the first bar surface 114 to a bottom 142 of the plurality of indentations 124. For any of the embodiments herein, the indentation depth 138 may be between 0.025 and 8 mm, in a preferred embodiment between 0.05 and 7 mm, and in a more preferred embodiment, between 0.1 and 0.5 mm.

For any of the embodiments herein, a width 144 of each one of the plurality of indentations 124 may be 0.25 and 8 mm, in a preferred embodiment between 0.5 and 7 mm and in a more preferred embodiment, between 0.1 and 5 mm. Preferably, the width 144 may be greater than the depth 138.

As illustrated, the plurality of indentations 124 may comprise a plurality of bar grooves 146 that extend parallel to one another. Further, at least some of the plurality of bar grooves 146 extend parallel to the longitudinal axis 128 and at least some of the bar grooves 146 are in an extension parallel to the horizontal axis 129.

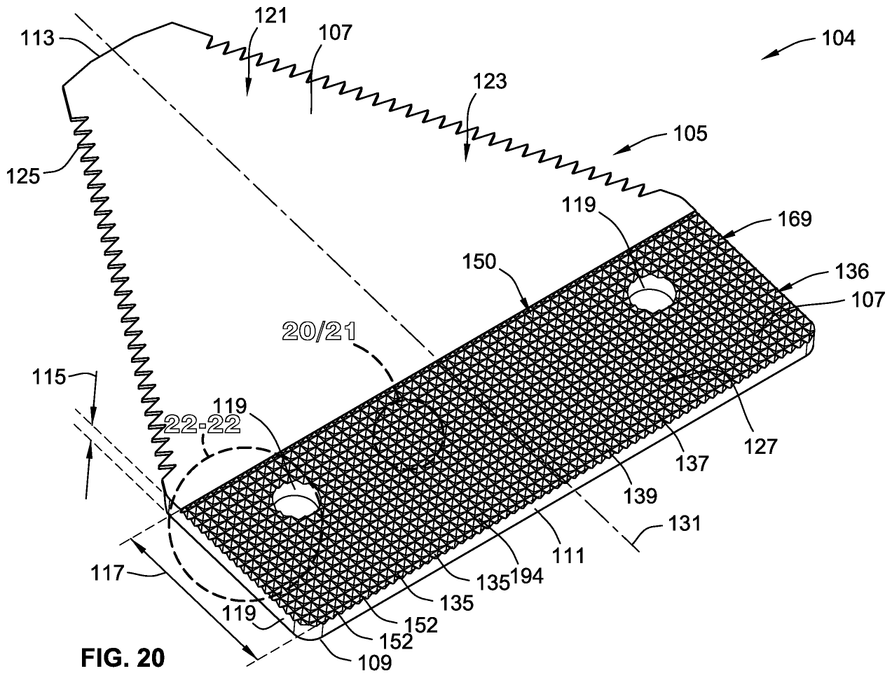

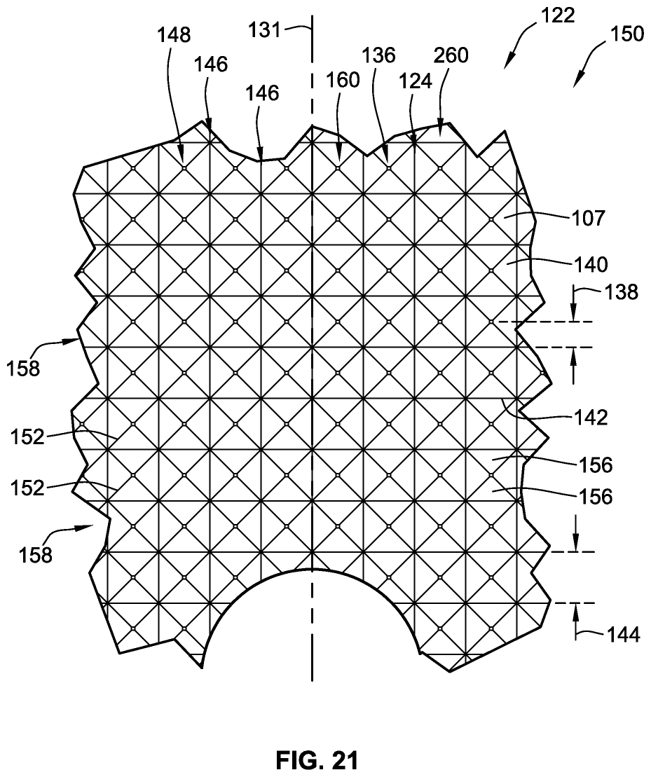

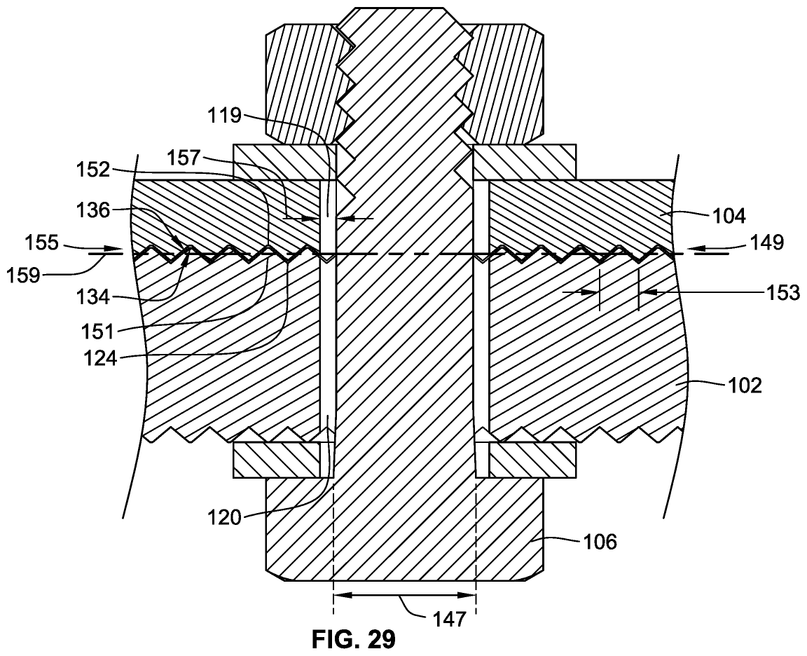

The pattern 134 may form projections such as a plurality of raised right regular pyramids 148 in the present embodiment. An apex 150 of each one of the right raised regular pyramids 148 defined by the first bar surface 114. The pattern 134 may be considered a male pattern and it is configured, that is sized and located, to mate with an inverse pattern 136 (FIGS. 20 and 21) that may be considered a female pattern (see also FIG. 29). The patterns 134, 136 cooperate to create a mechanical interlock when joined to one another.

The patterns 134, 136 may be reversed, that is the female pattern 136 may be formed in the sickle bar 102 and the male pattern 134 may be formed in the sickle cutting section 104 (FIG. 21) and the mechanical interlock would still be achieved as would the residual compressive strength where a cold forming process is utilized to form the patterns 134, 136. As previously, discussed, even where cold forming is not used, and instead a material removal process or cutting process is used to create the patterns 134, 136, fatigue strength may still be achieved either through the mechanical interlock when parts are mated, or alternatively where only one part has the male pattern 134 there may be improvement in joint robustness due to the increase in friction created at the joint which in turn improves fatigue strength.

FIGS. 6 and 7 schematically illustrate a top and bottom view, respectively, of another embodiment of a sickle bar 202 which is similar to the sickle bar 102 except the second bar surface 216 is a flat surface that extends along the second bar surface 216 from the first bar end 210 to the second bar end 226 to comprise a bar second side flat region 274. The sickle bar 102 may be reversed with the flat surface along the top in an alternative embodiment.

As heretofore described, fatigue strength may still be achieved where only one of the first bar surface 214 and the second bar surface 216 has formed therein the non-flat surface region 222 because of the residual compressive strength created in at least one of the bar surfaces 214,216. Moreover, even if a cold forming process is not used, as has been described, the first bar surface 214 with the non-flat surface region 222 may form a mechanical interlock when joined with an inverse patter of mating part which improves fatigue strength, independent of whether a cold forming process was used, that is, where a material removal or cutting process was used to form the at least one non-flat surface region 222. So too, the non-flat surface region 222 may improve joint robustness and may improve its fatigue strength where it is mated with, that is joined to, an entirely flat surface of a mating part.

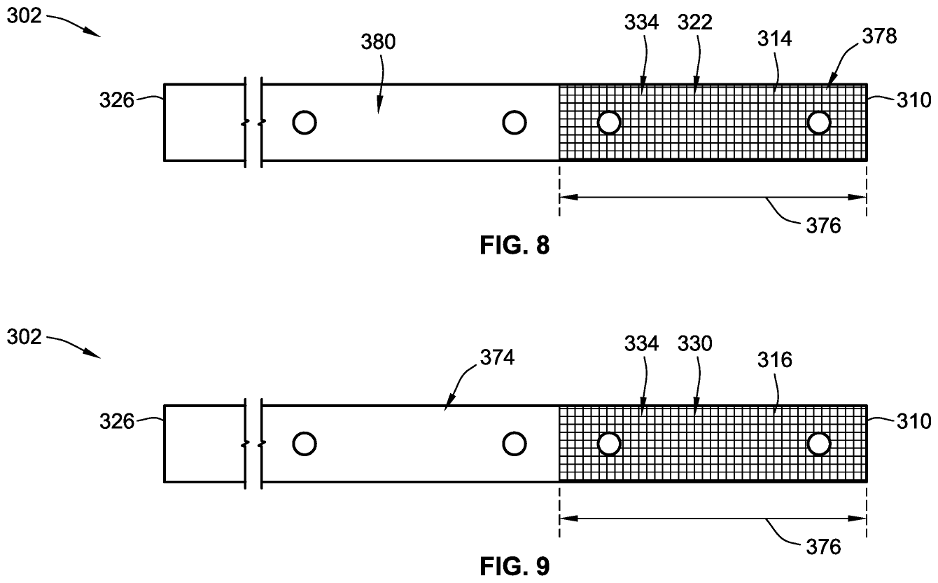

FIGS. 8 and 9 schematically illustrate a top and bottom view, respectively, of yet another embodiment of a sickle bar 302 which is similar to the sickle bar 102 except as described herein. A first bar surface 314 has formed therein a non-flat surface region 322 forming a pattern 334 extends from a first bar end 310 only a partial distance 376 towards second bar end 326 to form a first drive region 378 along first bar surface 314. A bar first side flat region 380 extends from the second end 326 to the first drive region 378. The first drive region 378 may form a mechanical interlock with a knife head or sickle cutting section or may create a friction fit where joined to a flat surface of a knife head or sickle cutting section.

A second bar surface 316 may have a second side non-flat surface region 330 formed therein to form the pattern 334 that extends the partial distance 376 with the remaining second bar surface 316 being a bar second side flat region 374. Alternatively, the entire second bar surface 316 may comprise the bar second side flat region 374 that extends from the first bar end 310 to the second bar end 326.

Alternatively, the second side non-flat surface region 330 may comprise a plurality of second side non-flat surface region 330 and the bar second side flat region 374 may comprise a plurality of bar second side flat regions 374. Each one of the plurality of second side non-flat surface regions 330 are evenly spaced between the first end 310 and the second bar end 326 with a one of the plurality of second side flat regions 374 located between each one of the plurality of second side non-flat surface regions 330.

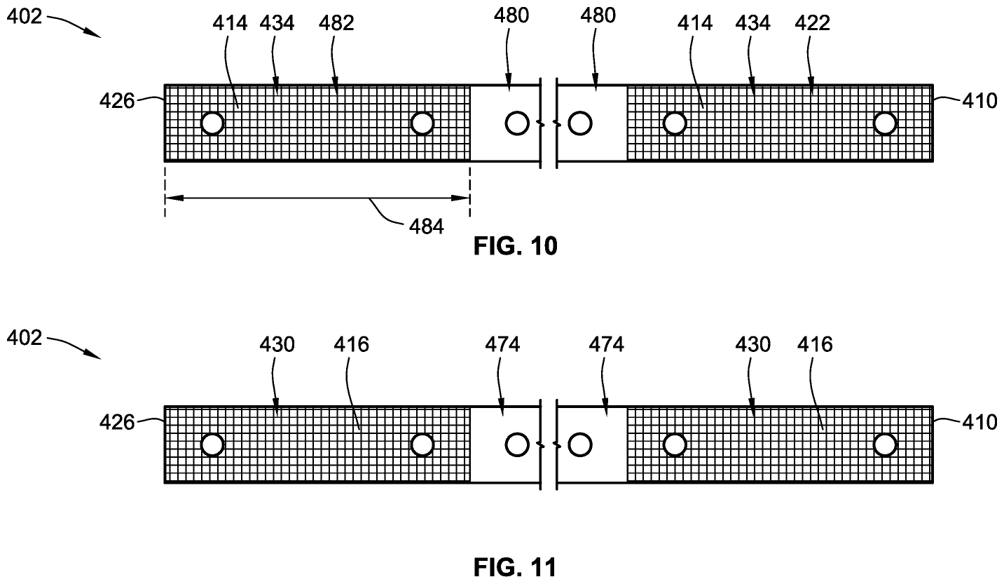

FIGS. 10 and 11 schematically illustrate a top and bottom view, respectfully of still another embodiment of a sickle bar 402. Sickle bar 402 is similar to sickle bar 302 except sickle bar 402 includes both a first end non-flat surface region 422 and a second end non-flat surface region 482 with both formed in a first bar surface 414 to create a pattern 434 in the first end non-flat surface region 422 and the pattern 434 in the second end non-flat surface region 482. The second end non-flat surface region 482 extends from the second bar end 426 a partial length 484 towards the first bar end 410 with a bar first side flat region 480 therebetween. The first end non-flat surface region 422 extends from the first bar end 410 the partial length 484 towards the second end 426. A bar first side flat region 480 is located between the first end non-flat surface region 422 and the second end non-flat surface region 482.

The second bar surface 416 may mirror the first bar surface 414 or alternatively may comprise a second side non-flat surface region 430 extending from the first bar end 410 to the second bar end 426 or alternatively may have a bar second side flat region 474 along the second bar surface 416 that extends from the first bar end 410 to the second bar end 426.

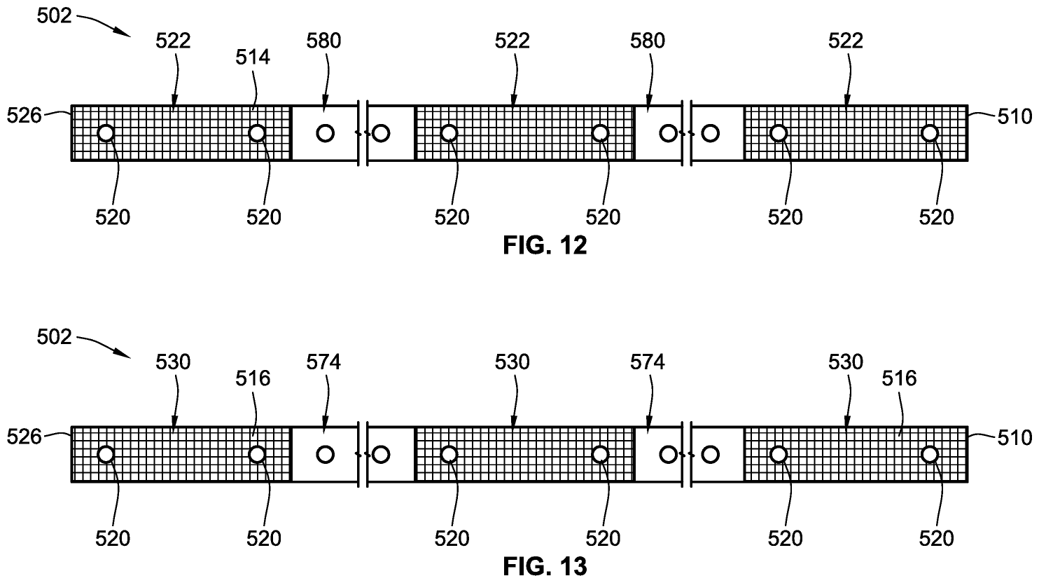

FIGS. 12 and 13 schematically illustrate a top and bottom view, respectfully, of an embodiment of sickle bar 502 which is similar to sickle bar 102 except sickle bar 502 has a non-flat surface region 522 formed in a first bar surface 514 that is a plurality of non-flat surface regions 522 evenly spaced from a first bar end 510 to a second bar end 526 with a one of a plurality of bar first side flat regions 580 between adjacent ones of the plurality of non-flat surface regions 522.

In the embodiment illustrated each one of the plurality of non-flat surface regions 522 surrounds a respective one of a plurality of bar apertures 520 as these locations may experience greater stress relative to the remainder of the sickle bar 502 because of the mounting thereto of the sickle cutting sections. Thus, the plurality of non-flat surface regions 522 may assist in improving fatigue strength about each one of the plurality of apertures 520 or as many as may be desired.

Where the cold forming process is used the sharpness of the plurality of bar apertures 520 at the first bar surface 514 may be decreased which provides for a smoother bearing surface to meet with the fasteners inserted therethrough which increases fatigue strength in both the fastener and the sickle bar 502. This same improvement may occur where the entire first bar surface 514 has the non-flat surface region 522 formed therein. However, forming the non-flat surface region in limited areas, such as about the first plurality of apertures 520, presents a potential elegant solution to potential forming problems/difficulties based on machine size and limitations in forming the entire first bar surface 514 that this embodiment resolves.

The second bar surface 516 may have a second side non-flat surface region 530 that is a plurality of second non-flat surface regions 530 that may be evenly spaced apart from the first bar end 510 to the second bar end 526 as described above with respect to the plurality of second side non-flat surface regions 530. A one of a plurality of bar second side flat regions 574 is located between each one of the plurality second non-flat surface regions 530, or alternatively the second side non-flat surface region 530 may extend from the first bar end 510 to the second bar end 526 to completely cover the second bar surface 516 or alternatively the second bar surface 516 may comprise a bar second side flat region 574 that extends from the first bar end 510 to the second bar end 526.

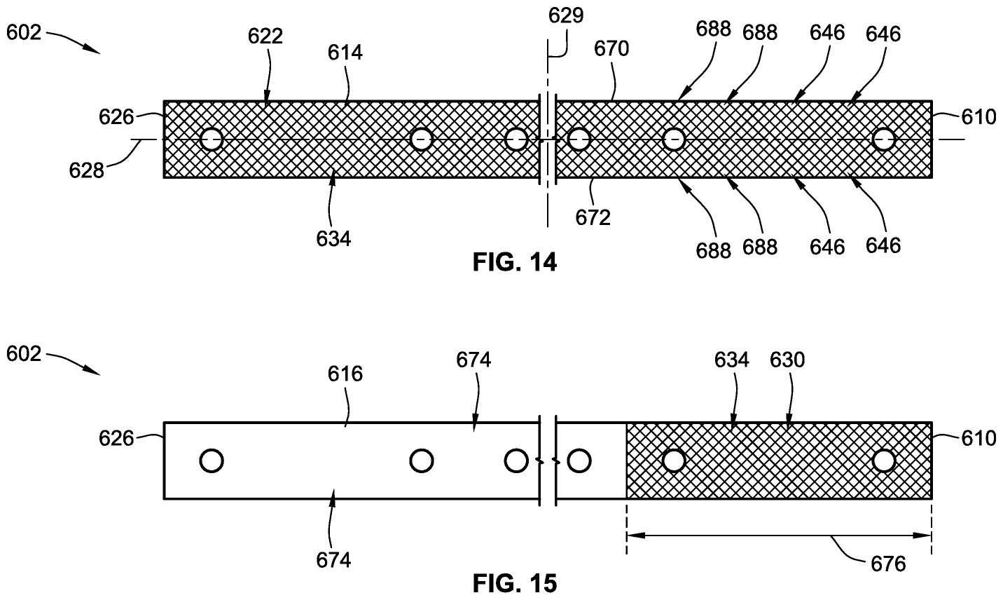

FIGS. 14 and 15 schematically illustrate a top and bottom view, respectfully, of an embodiment of sickle bar 602 that is similar to sickle bar 102 except for the differences described herein. Sickle bar 602 defines a longitudinal axis 628 bisecting a first bar end 610 and extending to a second bar end 626 to bisect the second end 626. A horizontal axis 629 extends perpendicular to the longitudinal axis 628 to bisect a first bar side 670 and a second bar side 672. A non-flat surface region 622 is formed along the first bar surface 614 and forms a diamond pattern 634 that may be a male or a female diamond pattern.

At least some of a plurality of bar grooves 646 are in an extension oblique to both the horizontal axis 629 and the longitudinal axis 628. Further, the plurality of bar grooves 646 define a first plurality of bar grooves 686 and a second plurality of bar grooves 688 that intersect to define the diamond pattern 634. As has been described in the previous embodiments, the non-flat surface region 622 may cover any portion of the length between the first bar end 610 to the second bar end 626 such that a flat region (not illustrated) covers the remainder of the length. Alternatively, the non-flat surface region 622 may comprise a plurality of non-flat surface regions 622 spaced along the first bar surface 614 and the flat region may comprise a plurality of flat regions such that a one of a the plurality of flat regions is located between an adjacent one of the plurality of non-flat surface regions 622. For example, the diamond pattern could be applied only proximate the bar apertures 620 or alternatively, for example may be proximate the first bar end 610.

A second side non-flat surface region 630 may be formed in the second bar surface 616 to form the diamond pattern 634. The second side non-flat surface region 630 may extend a partial distance 676 from the first end 610 towards the second bar end 626 or may extend the entire length between the first end 610 and the second end 626. Alternatively, the second side non-flat surface region 630 may be a plurality of second non-flat surface regions 630 that may be evenly spaced from the first bar end 610 to the second bar end 626 with a one of a plurality of bar second side flat regions 674 between adjacent ones of the plurality of second side non-flat surface regions 630. Alternatively, the second bar surface 616 may comprise a bar second side flat region 674 that extends from the first bar end 610 to the second bar end 626.

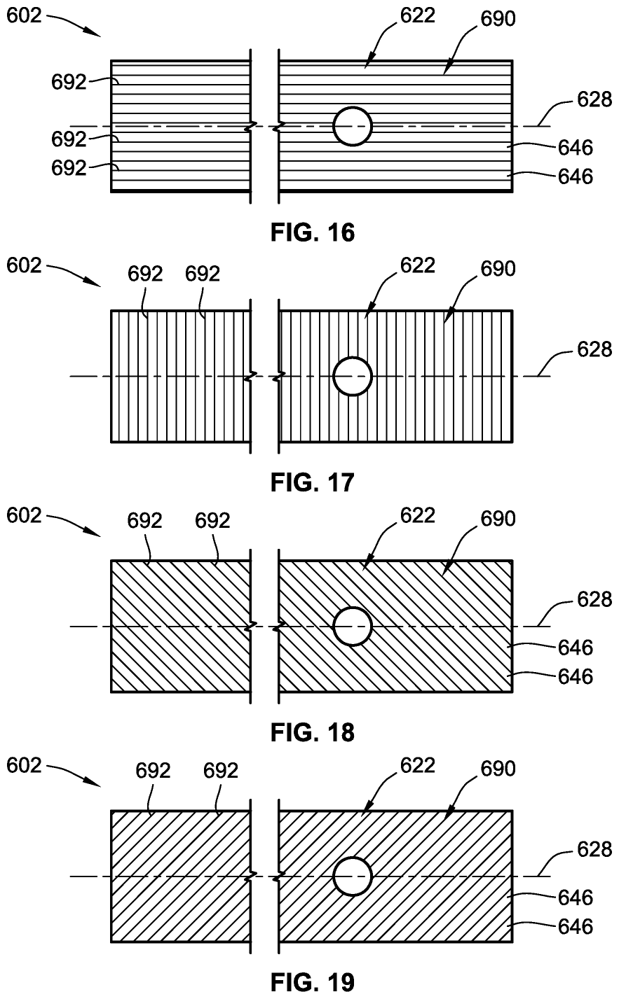

FIGS. 16-19 illustrate that alternative patterns 690 may be formed instead of the diamond pattern 634 in non-flat surface region 622 and/or second side non-flat surface region 630. These various alternative patterns 690 may be use as alternatives for any of the embodiments described herein. The plurality of bar grooves 646 may be formed in a single direction between adjacent ridges 692. The plurality of bar grooves 646 and the adjacent ridges 692 extend parallel to a longitudinal axis 628 (FIG. 16) or perpendicular to the longitudinal axis (FIG. 17) or oblique to the longitudinal axis 628 (FIG. 18 and FIG. 19). While these alternative patterns 690 may be formed in place of the diamond pattern 634 these same alternative patterns 690 can be used in place of pattern 134.

Referring to the sickle cutting section 104 in greater detail of FIG. 20 where a bottom view is shown and with additional reference to FIGS. 21-23, the sickle cutting section 104 is a plate 105 having a first surface 107 and a second surface 109, the first and second surfaces 107, 109 extend between an end 111 of the plate 105 to a tip 113 of the plate 105. A plate thickness 115 is defined between the first surface 107 and the second surface 109.

The first surface 107 of the plate 105 as applied to FIG. 1 embodiment is a bottom surface of the sickle cutting section 104 and includes a mounting portion 150 that extends a partial distance 117 from the end 111 to the tip 113 with the mounting portion 150 defining at least one mounting aperture 119 and two apertures as shown in this embodiment. A wedge portion 121 extends from the mounting portion 150 to the tip 113 of the plate 105 and comprises a wedge flat surface region 123. The wedge portion 121 defines a cutting edge 125. In embodiments the tip 113 is a plurality of tips 113 and the wedge portion 150 is a plurality of wedge portions 150 and the mounting portion 150 can have as many as four mounting apertures.

Typically the sickle cutting sections 104 have a first lateral dimension (width) of between 6 and 9 centimeters, a second later dimension (length) of between 6 and 9 centimeters and the thickness 115 is between 2 and 5 millimeters. In other embodiments wherein, there may be a plurality if tips and a plurality of wedge portions, the first lateral dimension (width) may be between 9.5 and 10.5 centimeters (cm). Sickle cutting section 104 may be wider or lager for example, as shown in U.S. Pat. No. 6,467,246 to McCredie, which are also covered by the claims appended hereto.

A first section non-flat surface region 127 is formed in the first surface 107 of the plate 105 along the mounting portion 150. The first section non-flat region 127 may be formed as has been described with respect to the non-flat surface region 122 of the sickle bar 102 (FIG. 2). For example, the first section non-flat region 127 may be formed by a cold forming process such as pressed knurling to leave a residual compressive stress in the plate 105 or may be formed by a material removal or cutting process.

As has been described, either process can create the inverse pattern 136 relative to pattern 134 (FIG. 5). The inverse pattern 136 and the pattern 134 create the mechanical interlock between the sickle cutting section 104 and the sickle bar 102 when joined as in FIG. 1.

The inverse pattern 136 is an interlocking pattern that defines a plurality of plate indentations 152 formed in the first surface 107 to form pattern locking features 156 that extend in parallel relationship and as an array. The inverse pattern 136 which is an interlocking pattern comprises rows 158 and columns 160 of the formed pattern locking features 156 that are polygonal features.

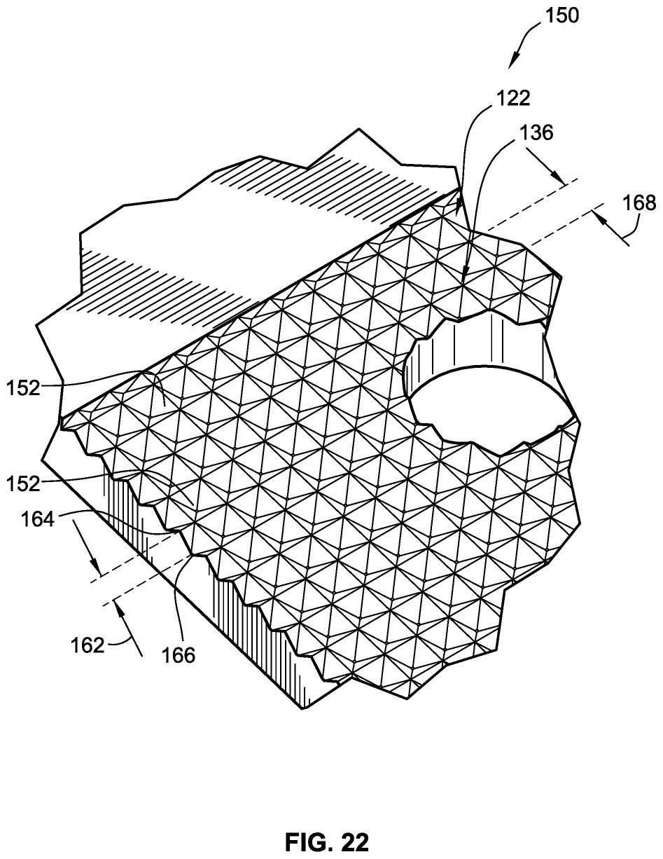

As best seen in FIG. 22, each one of the array plurality of the plate indentations 152 define an indentation depth 162 of between 0.1 and 5 mm, the plate indentation depth 162 measured from a section exterior 164 of the first surface 154 to a section bottom 166 of the plate indentations 152. In a preferred embodiment, the plate indentation depth 162 is between 0.1 and 0.5 mm. A section width 168 of the plate indentations 152 is between 1 and 5 millimeters as measured at the first surface 107. The section width 168 may be greater than the plate indentation depth 162.

The plate 105 defines a plate central axis 131 that extends perpendicularly relative to the end 111 and forwardly from the end 111 through the tip 113. The first section non-flat surface region 127 forms the plurality of plate indentations 152. At least some of the plurality of plate indentations 152 provide section grooves 135 and corresponding section ridges 137 between the section grooves 135 in an extension perpendicular to the plate central axis 131.

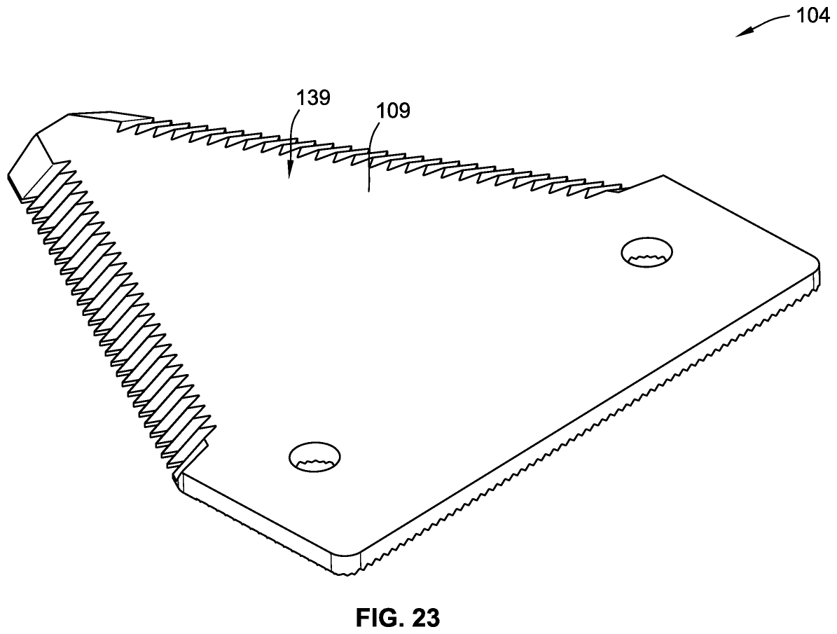

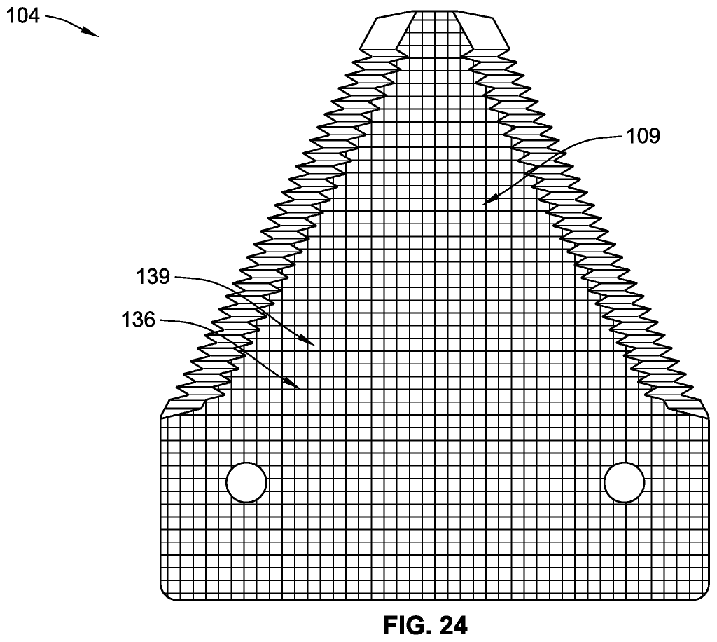

FIG. 23 illustrates a top view of the sickle cutting section 104 and the top surface 109. The top surface 109 may comprise and entirely flat region 139 along the entire second surface 109.

Alternatively, as seen in FIG. 23 the second surface 109 may include a second side non-flat region 139 that extends along the entire second surface 109 to form the inverse pattern 136.

It should also be noted that typically the sickle cutting sections 104 are not hardened prior to the forming of the first section non-flat surface region 127. However, after the sickle section 104 has had the first section non-flat surface region 127 formed, it may be subject to further hardening such as by heat treatment, however, in other embodiments no such subsequent heat treatment is provided.

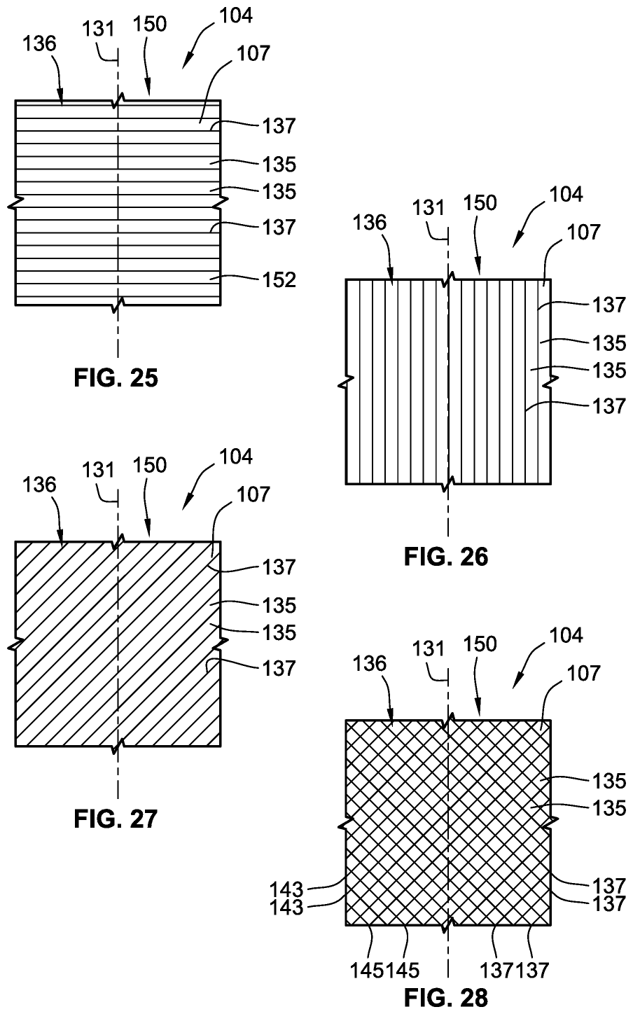

FIGS. 25-28 schematically illustrate the inverse pattern 136 may be formed along the mounting portion 150 of the first surface 107 and may take any number of alternative forms. The inverse pattern 136 with alternative forms can also be formed in the second surface 109 as desired.

FIG. 25 illustrate the inverse pattern 136 may have section ridges 137 with section grooves 135 defined by the plate indentations 152. The section grooves 135 are located between adjacent section ridges 137. Both the section ridges 137 and the section grooves 135 extend perpendicular to the plate central axis 131.

FIG. 26 illustrates the section ridges 137 and the section grooves 135 may extend parallel to the plate central axis 131.

FIG. 27 illustrates the section ridges 137 and the section grooves 135 may extend oblique to the plate central axis 131.

FIG. 28 illustrates the inverse pattern 136 can be a diamond pattern with section ridges 137 that may comprise a first plurality of ridges 143 and a second plurality of section ridges 145 that intersect to form the inverse the diamond pattern.

FIG. 29 is a partial schematic vertical cross section taken from section area 29 in FIG. 1. The fastener 106 is shown extending through the sickle bar 102 and the sickle section 104. Each fastener 106 has a shaft diameter 147. The fastener projects through one of the bar apertures 120 and one of the mounting apertures 119 of the sickle cutting section 104. As shown, when the sickle section 104 is joined to the sickle bar 102, a projection and receiver interface 149 is formed between the pattern 134 of the sickle bar 102 and the inverse pattern 136 of the sickle cutting section 104 that mechanically interlocks the sickle cutting section 104 to the sickle bar 102. The projection and receiver interface 149 is created when projections 151 of the sickle bar 102 project into the plate indentations 152 of the inverse pattern 136 of the sickle cutting section 104.

The indentations 124 of the sickle bar create the projections 151 that are spaced apart at a spacing 153 corresponding with an equal spacing between plate indentations 132 of the sickle cutting section 104 so as to define a registry 155. Each one of the plurality sickle cutting sections 104 is movable along the registry 155 at intervals equal to at least spacing 153. The shaft diameter 147 of the fasteners 106 is sized smaller than the each one of the mounting aperture 119 diameters to define clearance gap 157 that is sufficiently large to permit relative movement along a register longitudinal axis 159 between the sickle cutting sections 104 and the sickle bar 102 that is at least equal to the spacing 153. In this way, the clearance gap allows for misalignments between the patterns 134,136 on the sickle bar 102 and sickle cutting sections 104.

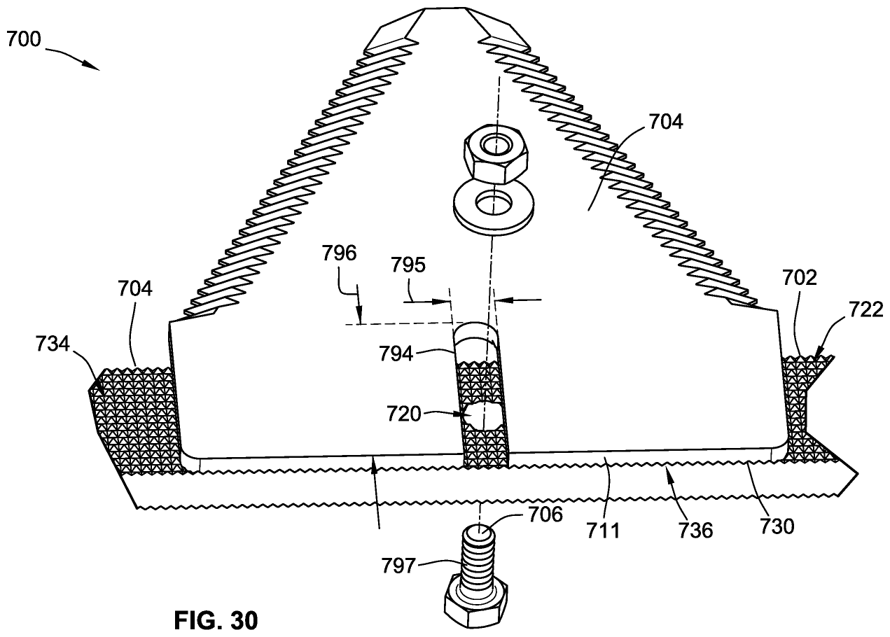

FIG. 30 illustrates a sickle cutting section 704 and a sickle bar 702 of an embodiment of a sickle bar assembly 700. The sickle bar 702 and the sickle cutting sections 704 are the same as sickle cutting section 104 (FIG. 1) and sickle bar 102 (FIG. 1) and their various embodiments except for the difference described here with respect to the reduced number of fasteners 706 required. The sickle cutting section 704 has an at least one mounting aperture 783 that may optionally be a slot 794 that receives a fastener shaft 797 for mounting the sickle cutting section 704 to the sickle bar 702. The fastener shaft 797 receives a nut and a load washer to join the sickle cutting section 704 to the sickle bar 702. The slot 794 is configured, that is sized and shaped to allow the sickle cutting sections 704 to be slideably inserted and removed between the load washer and the sickle bar 702 when the nut is fastened to the bolt.

The slot 794 may have a slot diameter 795 between 3 and 12.7 mm; in a preferred embodiment, the slot may have a diameter of between 4 and 11 mm; and in a more preferred embodiment between 4.7 and 9.5 mm. It should be noted that the at least one mounting aperture 119, as seen for example in FIG. 28 would have the same mounting aperture 119 diameter ranges as the slot 794. However, where a single mounting aperture 119 is formed that is the slot 794, the single fastener 706 that secures the sickle cutting section 704 to the sickle bar 702 may be sized slightly larger in diameter than each of the diameters of the two fasteners 106 so as to be able to withstand the forces acting on a single fastener 706 instead of the two fasteners 106.

The slot 794 opening may extend from the end 711 of the mounting portion of the sickle cutting section 704 a partial distance 796 towards the tip of the sickle cutting section. The distance may be between 10 and 20 mm; in a preferred embodiment between 12 and 18 mm and in a more preferred embodiment between 13.5 and 16 mm.

Mechanically interlocking the sickle bar 702 to the sickle cutting sections 704 with the non-flat surface regions 722, 730 allows for the reduction from two fasteners to a single fastener 706 combined or not with any shape washer or clamp load spreading and retention mechanism. Utilizing only the single fastener 706 to secure each sickle cutting section 704 to the sickle bar 702 reduces the sickle assembly 700 mass, cost, and failure origin possibilities by reducing the fastener 706 count by 50% across the entire length of the sickle bar 702. This fastening system enables and facilitates quick change of sickle cutting sections 704 in the field. Fast field service is further simplified by enabling sickle cutting section 704 removal without removal of the fastener 706. This is achieved by using the slot 794 mounting arrangement in the sickle cutting section 704. Use of the slot 794 is effective because the engineered mating inverse pattern of the joined sickle cutting section 704 and pattern 734 formed in the sickle bar 702 reduces the reliance of locating and load carrying from the fasteners 706.

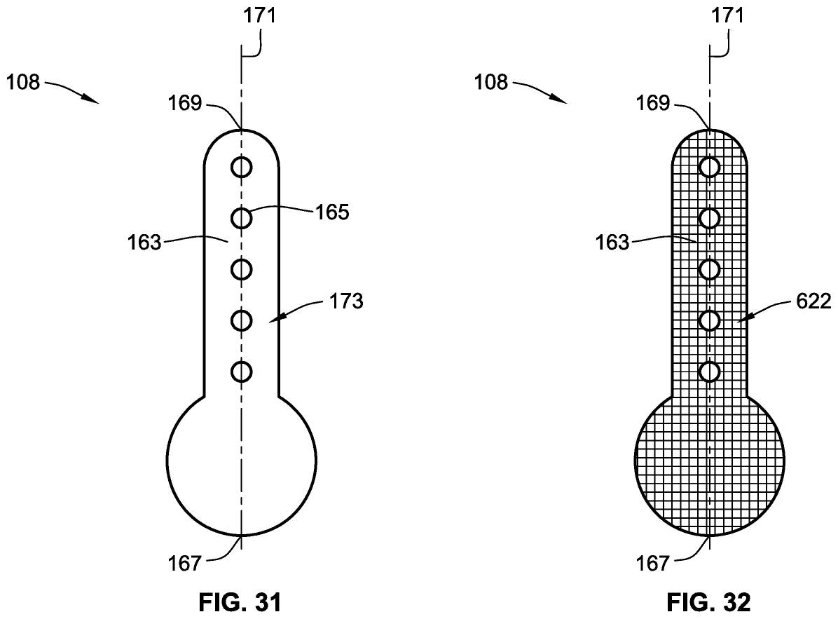

FIG. 31 schematically illustrates the bottom view of the knife head 108 of FIG. 1. Knife head 108 includes a bottom mating surface 163. A plurality of head apertures 165 extend along the entire length of the knife head 108 from a proximal end 167 to a distal end 169. A head central longitudinal axis 171 bisects the knife head 108 in extension from the proximal end 167 to the distal end 169. As seen in FIG. 1, the bottom mating surface 163 joins with the first bar surface 107 of the sickle cutting section 104, but in other embodiments the bottom mating surface 163 may join directly with the first bar surface 114.

The bottom mating surface 163 may be an entirely flat region 173 extending along the entire bottom mating surface 163 from the proximal end 167 to the distal end 169. Alternatively, as seen in FIG. 32, a knife non-flat surface region 622 may be formed in the bottom mating surface 163 that extends long the bottom mating surface 163 from the proximal end 167 to the distal end 169.

Any of the patterns 134, 634, alternative patterns 690, or inverse patterns 136 can be formed in the bottom mating surface 163. Leaving the bottom mating surface 163 flat or forming a pattern 134 therein can be based on whether the bottom mating surface 163 is intended to mate with the sickle cutting section 104 or the sickle bar 102 and whether an interlocking pattern providing a mechanical interlock is desired or whether the friction provide by a joint having only one surface with a pattern is desired.

The knife head 108 typically has a length defined between the proximal end 167 to the distal end 169 of between 10 and 122 cm and a thickness of between 0.2 and 5 cm. The knife head may have a width that tapers from the proximal end to the distal end and typically has a width of between 15 to 155 mm. In a preferred embodiment the narrowest width of the knife head is between 15 and 20 mm and the widest width is between 125 and 175 mm. In a more preferred embodiment, the narrowest width is between 16 and 19 mm and the widest width between 140 and 160 mm.

The entire knife head 108, in an embodiment, may be hardened, for example by heat treatment before and then after the cold forming or machining process to create the knife non-flat surface region 622. Alternatively, the knife head 108 may not be hardened before or after the cold forming or machining process. Alternatively, the knife head 108 is not hardened before the cold forming or machine removal but is subject to subsequent hardening to further improve fatigue strength after the cold forming or machine removal processes.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A sickle bar for mounting a plurality of sickle cutting sections along a length of the sickle bar, the sickle bar comprising:
a first bar surface and a second bar surface, a bar thickness defined between the first bar surface and the second bar surface;
a plurality of bar apertures extending through the first and second bar surfaces arranged to facilitate mounting of the sickle cutting sections;
wherein the first bar surface includes a non-flat surface region comprising a plurality of indentations formed therein.

2. The sickle bar of claim 1, wherein a cold formed and plastically deformed surface is defined along the non-flat surface region with the plurality of indentations press formed into the first bar surface.

3. The sickle bar of claim 1 wherein the plurality of indentations are formed in a regular pattern.

4. The sickle bar of claim 1, wherein the non-flat surface region is formed at spaced apart locations proximate opposed ends of the sickle bar with a flat surface region along the first bar surface between the spaced apart locations.

5. The sickle bar of claim 1, wherein the non-flat surface region extends completely over the length along the first bar surface.

6. The sickle bar of claim 1, wherein the plurality of indentations define an indentation depth of between 0.1 and 5 mm, the indentation depth measured from an exterior of the first bar surface to a bottom of the indentations.

7. The sickle bar of claim, 5, wherein the width of each one of the plurality of indentations is between 1 and 5 millimeters, and wherein the width is greater than the depth.

8. The sickle bar of claim 5, wherein an indentation depth of each one of the plurality of indentations is between 0.1 and 0.5 mm.

9. The sickle bar of claim 1, wherein the non-flat bar surface of the first bar surface defines a sickle bar interlocking pattern.

10. The sickle cutting section of claim 9, wherein the plurality of indentations comprise a plurality of bar grooves that extend parallel to one another.

11. The sickle bar of claim 10, wherein the bar defines a longitudinal axis along the length thereof and a horizontal axis perpendicular to the longitudinal axis, wherein at least some of the plurality of bar grooves are in an extension parallel to the longitudinal axis.

12. The sickle bar of claim 10, wherein the bar defines a longitudinal axis along the length thereof and a horizontal axis perpendicular to the longitudinal axis, wherein at least some of the bar grooves are in an extension parallel to the horizontal axis.

13. The sickle bar of claim 10, wherein the bar defines a longitudinal axis along the length thereof and a horizontal axis perpendicular to the longitudinal axis, wherein at least some of the plurality of bar grooves are in an extension oblique to both of the horizontal and the longitudinal axis.

14. The sickle bar of claim 10, wherein bar ridges are defined between adjacent ones of the plurality of bar grooves.

15. The sickle bar of claim 10, wherein intersecting bar grooves of ones of the plurality of bar grooves include a first set of bar grooves and a second set of bar grooves that intersect to define a diamond pattern.

16. The sickle bar of claim 15, wherein diamond pattern is a male diamond pattern comprising a plurality of raised right regular pyramids, an apex of each one of the right raised regular pyramids defined by the first bar surface, wherein the male diamond pattern is configured to mate with the female diamond pattern of a sickle cutting section in an interlocking fashion when the sickle cutting section is mounted to the sickle bar.

17. The sickle bar of claim 1, wherein the second bar surface defines a second non-flat bar surface similarly comprising the plurality of indentations formed therein.

18. A method of making the sickle bar of claim 1, comprising cold pressing the plurality of indentations into at least the first bar surface body to form the non-flat surface region.

19. The method of claim 18, wherein the pressing comprises knurling.

20. A sickle bar assembly comprising the sickle bar of claim 1 in combination with a plurality of the sickle cutting sections and further comprising a plurality of fasteners, at least one of the plurality fasteners secures a corresponding one of the plurality of sickle cutting sections to the sickle bar, each one of the plurality the sickle cutting sections being mechanically interlocked via a projection and receiver interface therebetween utilizing the plurality of indentations with portions of the sickle cutting sections receiving projections created by the indentations.

21. The sickle bar assembly of claim 20, wherein each one of the plurality sickle cutting sections include sickle section apertures, wherein each one of the plurality the fasteners includes a shaft projecting through one the plurality of bar apertures and one of the plurality of sickle section apertures, wherein the plurality of indentations define a registry with a spacing such that each one of the plurality sickle cutting sections are movable along the registry in intervals corresponding to the spacing, wherein the shaft is sized smaller than each one of the plurality of sickle cutting section apertures to define clearance gap relative that is sufficiently large to permit relative movement between the sickle cutting section and the sickle bar of at least the interval.

22. The sickle bar assembly of claim 21, wherein each one of the plurality of fasteners when fastened fully clamp and interlock each one of the plurality of the sickle cutting sections with the sickle bar utilizing the plurality of indentations such that the shafts of the fasteners experience tension loading and shear forces are carried by the projection and receiver interface along the non-flat surface region through the plurality of indentations rather than through the shaft extending through each one of the fasteners.

23. A method of making the sickle section of claim 1, comprising machining to remove material to form the plurality of indentations into at least the first bar surface to form the non-flat surface region.

24. The sickle bar of claim 1, wherein the first non-flat region comprises portions of non-flat regions surrounding each one of the plurality of bar apertures and wherein a plurality of flat regions on the first bar surface are evenly spaced between each one of the portions.

25. An apparatus including the sickle bar assembly of claim 20, further comprising at least one knife head, the at least one knife head having a non-flat knife surface region on a mating surface.

26. The apparatus of claim 25, wherein the non-flat knife surface region on the mating surface is in pattern to allow for a mechanical interlock with the non-flat surface region of the first bar surface when the knife head is mounted on the sickle bar.

27. A sickle cutting section, comprising:
a plate comprising a first surface and a second surface, the first and second surfaces extending between an end of the plate to a tip of the plate, a plate thickness being defined between the first surface and the second surface;
the plate including a mounting portion extending a partial distance from the end to the tip with the mounting portion defining a mounting aperture, and a wedge portion extending from the mounting portion to the tip of the plate, the wedge portion defining a cutting edge;
wherein the first surface of the plate along the mounting portion defines a first non-flat surface.

28. The sickle cutting section of claim 27, wherein the first non-flat surface defines a sickle cutting section interlocking pattern.

29. The sickle cutting section of claim 28, wherein the first surface of the plate along the wedge portion defines a first flat surface adjacent to the first non-flat surface.

30. The sickle cutting section of claim 28, wherein the sickle cutting section interlocking pattern defines an array plurality of indentations formed into the first surface that for form interlocking pattern locking features that extend in parallel relationship.

31. The sickle cutting section of claim 29, wherein the indentations define a indentation depth of between 0.1 and 5 mm, the indentation depth measured from an exterior of the first surface to a bottom of the indentations.

32. The sickle cutting section of claim, 31, wherein the width indentations is between 1 and 5 millimeters as measured at the first surface, and wherein the width is wider than the depth.

33. The sickle cutting section of claim 31, wherein the indentation depth is between 0.1 and 0.5 mm.

34. The sickle cutting section of claim 30, wherein the plate defines a plate central axis, the plate central axis perpendicularly relative to the end and forwardly from the end through the tip, wherein at least some of the indentions provide section grooves and corresponding ridges between grooves in an extension perpendicular to the plate central axis.

35. The sickle cutting section of claim 30, wherein the plate defines a plate central axis, the plate central axis perpendicularly relative to the end and forwardly from the end through the tip, wherein at least some of the indentions provide section grooves and corresponding ridges between grooves in an extension parallel to the plate central axis.

36. The sickle cutting section of claim 30, wherein the plate defines a plate central axis, the plate central axis perpendicularly relative to the end and forwardly from the end through the tip, wherein at least some of the indentions provide section grooves and corresponding ridges between grooves in an extension oblique to the plate central axis.

37. The sickle cutting section of claim 28, wherein the interlocking pattern comprises an array comprising rows and columns of formed polygonal features formed into the first non-flat surface.

38. The sickle cutting section of claim 38, wherein the interlocking pattern is a female diamond pattern, the formed polygonal features comprising a plurality of inverted pyramids having a base at the first face and an apex extending away from the base towards the second face.

39. The sickle cutting section of claim 27, wherein the at least first mounting aperture is a slot.

40. A method of making the sickle cutting section of claim 27, comprising cold pressing indentations into a sickle section metal body to form the first non-flat surface.

41. The method of claim 40, wherein the pressing comprises coining.

42. The method of making the sickle cutting section of claim 27, comprising machining to remove material.

43. A sickle bar assembly, comprising:
a sickle bar;
a plurality of sickle cutting sections joined to the sickle bar;
a non-flat interface between the sickle bar and at least one of the plurality of sickle cutting sections;
wherein the non-flat interface comprises a non-flat surface region.

44. The sickle bar assembly of claim 43, wherein the non-flat surface region is on the at least one of the plurality of the sickle cutting sections and the sickle bar.

45. The sickle bar assembly of claim 44, wherein the non-flat surface region is located only on the sickle bar.

46. The sickle bar assembly of claim 43, wherein the non-flat surface regions is located only on the at least one of the plurality sickle cutting section.

47. The sickle bar assembly of claim 44, wherein the non-flat surface region is an interlocking pattern.

48. The sickle bar assembly of claim 45, wherein the first sickle bar comprises:
a first bar surface and a second bar surface, a bar thickness defined between the first bar surface and the second bar surface;
a plurality of bar apertures extending through the first and second bar surfaces;
wherein the first bar surface defines a first sickle bar interlocking pattern, the first sickle bar interlocking pattern defining a plurality of bar grooves that are generally parallel to one another, wherein the sickle bar interlocking pattern is sized and shaped to interlock with the sickle cutting section interlocking pattern when any one of the at least two of the plurality of sickle cutting sections is secured to the first sickle bar at a one of the plurality of bar apertures.

49. The sickle bar assembly of claim 45, wherein the first sickle bar comprises:
a first bar surface and a second bar surface, a bar thickness defined between the first bar surface and the second bar surface;
a plurality of bar apertures extending through the first and second bar surfaces;
wherein the first bar surface defines a first sickle bar interlocking pattern, the first sickle bar interlocking pattern defining a male diamond pattern, wherein the sickle bar interlocking pattern is sized and shaped to interlock with the sickle cutting section interlocking pattern when any one of the at least two of the plurality of sickle cutting sections is mounted to the first sickle bar at a one of the plurality of bar apertures.

50. The sickle bar assembly of claim 43, wherein the second surface of the mounting portion defines a second non-flat surface.

51. The sickle bar assembly of claim 49, wherein the second bar surface defines a second bar interlocking pattern, the second sickle bar interlocking pattern the same as the first bar interlocking pattern.

52. The sickle bar assembly of claim 43, wherein the at least first mounting aperture is a slot, the slot, the slot having an open end at the end of the sickle cutting section, the opening of the slot having a slot diameter of between 3.0 and 12.7 mm.

53. The sickle bar assembly of claim 43, wherein the first sickle bar defines a plurality of first sickle bar apertures, each one of the plurality of first sickle bar apertures axially aligned with a respective one of the at least first mounting apertures of the sickle cutting section and receiving a fastener there through to secure the at least two of the plurality of sickle cutting sections secured to the first sickle bar.

54. The sickle bar assembly of claim 54, wherein the fastener includes a nut and a load washer.

55. The sickle bar assembly of claim 54, wherein the slot is configured to allow each one of the plurality of sickle cutting sections to be slideably inserted and removed between the load washer and the first sickle bar when the nut is fastened to the bolt.

56. A knife head, the knife head comprising:
a knife body having a top surface and a bottom surface and a knife thickness defined between the top and bottom surfaces;
a plurality of knife apertures extending through the top and bottom surfaces arranged to facilitate mounting to a sickle bar assembly;
wherein the bottom surface includes a non-flat surface region comprising a plurality of indentations formed therein.

57. The knife head of claim 56, wherein a cold formed and plastically deformed surface is defined along the non-flat surface region with the plurality of indentations press formed into the bottom surface.

58. The knife head of claim 56, wherein the plurality of indentations are formed in a regular pattern.

59. The knife head of claim 56, wherein the non-flat surface region extends completely over the length along the bottom surface.

60. The knife head of claim 59, wherein the non-flat surface region is formed by a material removal process.

61. The sickle bar of claim 2, wherein the cold formed and plastically deformed surface forms a rounded bearing surface at the opening of each one of the plurality of bar apertures at the first bar surface to reduce a bolt load when a bolt is inserted therethrough.
